(19) United States
(12) Patent Application Publication
(10) Pub. No.: US 2026/0346904 A1
(43) Pub. Date: Nov. 5, 2026

(54) OPERATING UNIT, METHOD FOR TESTING THE FUNCTIONALITY OF A MAGNETORHEOLOGICAL BRAKE, COMPUTER PROGRAM PRODUCT, AND STEER-BY-WIRE SYSTEM

(71) Applicant: Schaeffler Technologies AG & Co. KG, Herzogenaurach (DE)

(72) Inventors: Martin VORNEHM, Bühl (DE); Simon DIRAUF, Walsdorf (DE); Fabian DREYER, Erlangen (DE); Benjamin SEVERIN, Baiersbronn (DE); Jannick ALTHERR, Bühl (DE); Dominik REIF, Großenseebach (DE)

(73) Assignee: Schaeffler Technologies AG & Co. KG, Herzogenaurach (DE)

(21) Appl. No.: 19/486,142

(22) PCT Filed: Apr. 16, 2024
(86) PCT No.: PCT/DE2024/100321

§ 371 Date: Nov. 20, 2025

(30) Foreign Application Priority Data
May 22, 2023 (DE) 10 2023 113 235.0

(51) Int. Cl. B62D 5/00; B60K 31/00; G07C 5/00; G07C 5/08

(52) U.S. Cl. CPC B62D 5/005; B60K 31/00; G07C 5/0808; G07C 5/0825; G07C 5/0833; B60K 2031/0091; G07C 5/008

(57) ABSTRACT

An operating unit for influencing the driving direction of a motor vehicle by means of a user, comprising a rotatably mounted steering shaft, which can be coupled to a steering means, a force-feedback actuator, which is connected to the steering shaft so as to transmit a torque, a magnetorheological brake, which is likewise connected to the steering shaft so as to transmit the torque, and a control unit for controlling the operating unit. The control unit is designed to retrieve a program for a functional test of the magnetorheological brake according to a trigger signal and to run the program, the control unit provides an error signal if it is ascertained that the magnetorheological brake has fallen below a specified braking effect.

### CROSS-REFERENCE TO RELATED APPLICATIONS

This application is the U.S. National Phase of PCT Appln. No. PCT/DE2024/100321, filed Apr. 16, 2004, which claims the benefit of German Patent Appln. No. 102023113235.0, filed May 22, 2023, the entire disclosures of which are incorporated by reference herein.

### TECHNICAL FIELD

The present disclosure relates to an operating unit for influencing a driving direction of a motor vehicle by a user, comprising a rotatably mounted steering shaft, which can be coupled to a steering means, a force-feedback actuator, which is connected to the steering shaft in a torque-transmitting manner, and a magnetorheological brake, which is likewise connected to the steering shaft in a torque-transmitting manner, and a control unit for controlling the operating unit. The disclosure further relates to a method for testing the functionality of a magnetorheological brake, a computer program product and a steer-by-wire system.

### BACKGROUND

Electric steering devices are used—among other applications in motor vehicles—to receive a directional request from a driver and convert it into corresponding movements of one or more road-end wheels. Compared to purely mechanical steering devices, with electric steering devices, a distinction is made between electrically assisted steering devices and fully electric steering devices, i.e., steer-by-wire steering devices. In particular, these steer-by-wire steering devices have the advantage that the operating unit can be positioned relatively freely within the vehicle independently of mechanical connection components, which in addition to cost savings when distinguishing between right-hand and left-hand drive vehicles, for example, also improves accident behavior due to the absence of a steering column. Furthermore, the operating unit can be brought into a stowed position, which is also used, for example, with fully automatic steering.

A steer-by-wire steering system within the meaning of the present disclosure is to be understood as meaning a steering system which essentially consists of a hand wheel actuator (HWA), for example the actuator system around the commanding vehicle steering wheel, and a road wheel actuator (RWA), i.e., the actuators acting on the steering mechanism connected to the vehicle wheels. The steering signal is transmitted in this case by wire from the HWA to the RWA.

In order to create a realistic driving experience, it is also known in the prior art to record parameters such as vehicle speed, steering angle, lateral acceleration, tie rod force and the like from an actual current driving situation or to calculate them in a simulation and to form a feedback signal from these, which is fed into a force-feedback actuator. The force-feedback actuator is integrated into the input unit and has an actuator unit that comprises an actuator that serves as a manual torque or steering wheel actuator and that, depending on the feedback signal, couples a feedback torque that at least partially corresponds to the real reaction torque into the steering wheel via the steering shaft. A partial feedback torque is particularly suitable when other, possibly controllable components such as springs or brakes provide additional feedback torques. The term feedback torque refers to both directions of action, i.e., the feedback actuator can be rotated by the driver as an adjustable load. Such force-feedback systems give the driver the impression of a real driving situation, as with conventional steering, which facilitates intuitive response.

From DE 102008036730 A1, a steer-by-wire steering system with an input unit is known, which has an actuator unit driven by an electric motor. The electric motor can be controlled by an electronic control unit, which adjusts the motor current depending on measured values that characterize the respective driving situation.

The motor shaft is directly coupled to the steering shaft, so the motor torque is identical to the manual torque coupled into the steering shaft. The electric motor is flanged axially to the casing unit with respect to the longitudinal axis and the motor shaft is connected via a coupling to the steering shaft mounted in the casing unit. An actuator unit with a similar structure is shown in EP 2414211 B1. In the embodiment described therein, the steering shaft itself forms the motor shaft of the electric motor so that a more compact design can be realized.

In this context, it is also known to provide electric motor-driven force-feedback actuators with a transmission for improved adaptation of speeds and torques. For example, electric motors with a worm drive at the end of the steering column are known, which are connected to the steering wheel by means of a shaft. An example of this embodiment can be found in DE 102018101528B4. With these transmissions, comparatively high transmission ratios and thus high torques can be achieved or maintained, but the relatively large installation space requirement and the angled design are often disadvantageous. Furthermore, such force-feedback actuators coupled with a worm drive usually have to be optimized with great effort in terms of precision and material selection with regard to friction (usually too high) and uniformity of friction (usually too uneven).

In addition to worm drives, it is also known to connect an electric motor of a force-feedback actuator with a planetary transmission at the end of the steering column, which is described, for example, in CN215706606U. However, with planetary transmissions, usually only moderate transmission ratios and thus torques can be achieved in one stage. The use of friction or loss torque for force-feedback requires additional effort and friction devices.

In principle, direct-drive force-feedback actuators are also known, which are sometimes also referred to as direct drive. Examples of such designs can be found, for example, in CN112644580B or DE102018101528B4. In principle, such direct-drive force-feedback actuators require a telescopic steering shaft at the far end of the steering column, which is associated with costs and space requirements.

Steering columns with a direct-drive force-feedback actuator near the steering wheel are disclosed, for example, in EP3960583A1 and EP3476692B1. These also disclose the option of the stationary steering column part being positioned radially inside and the rotating steering wheel part being positioned radially outside, which then also applies to the force-feedback actuators as the motor (outer rotor) and/or magnetorheological brake (outer rotor).

In order to achieve the most realistic steering feel possible in such steer-by-wire systems, it is also known to arrange a magnetorheological brake in the torque flow of a steering device to increase the modulus of resistance. In combination, this makes it possible to achieve a higher total restoring torque with lower energy consumption in the same installation space.

With such magnetorheological brakes (whether inner or outer rotor), an immediate or gradual failure of the magnetorheological brake can occur, for example as a result of seal failure or powder degradation.

### SUMMARY

In light of this prior art, it is now an object of the disclosure to provide an operating unit for influencing a driving direction of a motor vehicle by a user, which can detect such a loss of braking force of the magnetorheological brake and initiate countermeasures and/or warning measures. It is further an object of the disclosure to realize an optimized method for testing the functionality of a magnetorheological brake and to provide a correspondingly improved computer program product and steer-by-wire system.

This object is achieved by an operating unit for influencing a driving direction of a motor vehicle by a user, comprising a rotatably mounted steering shaft, which can be coupled to a steering means, and a force-feedback actuator, which is connected to the steering shaft in a torque-transmitting manner, and a magnetorheological brake, which is likewise connected to the steering shaft in a torque-transmitting manner, and a control unit for controlling the operating unit, wherein the control unit is designed to call up and execute a program for testing the functionality of the magnetorheological brake after a trigger signal, wherein the control unit provides a fault signal if it is ascertained that the magnetorheological brake has fallen below a predefined braking effect, wherein the program is configured such that the force-feedback actuator provides a motor torque M_{EM} and a test torque M_{R} is applied to the magnetorheological brake, and the actual parameter which represents the braking effect is the angular position of the magnetorheological brake when the test torque M_{R} is applied.

This has the advantage that a reduction in braking force or a failure of the magnetorheological brake can be detected at an early stage. It is also possible to temporarily or partially compensate for a detected reduction in braking force-either by means of the brake itself (for example by temporarily energizing it more strongly) or by another feedback actuator (for example by a second brake or by an electric motor that is temporarily energized more strongly).

The magnetorheological brake can be designed as an outer or inner rotor.

The magnetorheological brake can provide a magnetic field by means of an energizable electromagnet and/or a permanent magnet, wherein the magnetic field acts on a magnetorheological medium. Preferably, the strength of the magnetic field acting on the magnetorheological medium can be adjusted.

The magnetorheological brake can be designed as a powder brake, which is based on the well-known effect that, for example, iron powder clumps under the influence of a magnetic field or forms threads along the field lines. These threads or lumps generate a braking force or braking torque through magnetic adhesion between a moving and a stationary iron part. When the magnetic field is deactivated, the braking effect decreases as desired, which is due on the one hand to the then beginning isolation of the typically 10-100 μm small particles, and on the other hand to the particle displacement from the shear zones into neighboring rest zones. There is a magnetic field gradient in the rest zones so that when the brake is activated, the particles migrate back from the rest zones to the shear zones. The magnetorheological powder is surrounded by air or a gas, which is easily compactable and has low viscosity.

Alternatively, the medium may be a liquid and particularly preferably a magnetorheological liquid. Magnetorheological liquids have the property that they can change their viscosity by several orders of magnitude depending on the magnetic field passing through them. The term “magnetorheological fluid” (MRF) refers to liquids that react to a magnetic field in a similar way to ferrofluids, but unlike ferrofluids, they solidify. Magnetorheological fluids, for example, consist of a suspension of micrometer-sized magnetic particles that are one to three orders of magnitude larger than the particles of ferrofluids. The relatively large particles of magnetorheological fluids form chains when a magnetic field is applied. This increases the viscosity of the MRF and can even solidify it if the applied compressive force is not large enough to break the chains.

The use of the operating unit in an HWA (hand wheel actuator) of a steer-by-wire system is particularly preferred.

The steering shaft can be connected to a steering device in a rotationally fixed manner. The steering means can preferably be designed as a steering wheel. In principle, it would also be possible to design the steering means as a steering bracket.

The operating unit can further have a control unit. A control unit, as used in the present disclosure, serves in particular for electronic open-and/or closed-loop control of one or more technical systems of the operating unit, in particular the force-feedback actuator and/or the magnetorheological brake.

In particular, a control unit has a wired or wireless signal input for receiving signals, in particular electric signals, such as a trigger signal and/or sensor signals.

Furthermore, a control unit likewise preferably has a wired or wireless signal output for transmitting signals, in particular electric signals, for example to the force-feedback actuator and/or the magnetorheological brake or other electric consumers of the operating unit.

Open-loop control operations and/or closed-loop control operations can be carried out within the control unit. It is very particularly preferable that the control unit comprises hardware that is designed to run software. The control unit preferably comprises at least one electronic processor for executing program sequences defined in software.

The control unit can also have one or more electronic memories in which the data contained in the signals transmitted to the control unit can be stored and read out again. Furthermore, the control unit can have one or more electronic memories in which data can be stored in a modifiable and/or non-modifiable manner.

A control unit can comprise a plurality of controllers, which are arranged in particular spatially separate from one another in or on the operating unit or in the motor vehicle. Controllers are also referred to as electronic control units (ECU) or electronic control modules (ECM) and preferably have electronic microcontrollers for carrying out computing operations for processing data, particularly preferably using software. The controllers can preferably be interconnected with one another such that a wired and/or wireless data exchange between control units is made possible. In particular, it is also possible to interconnect the controllers with one another via bus systems present in the motor vehicle, such as a CAN bus or LIN bus, for example.

Very particularly preferably, the control unit has at least one processor and at least one memory, which in particular contains a computer program code, wherein the memory and the computer program code are configured to cause the control unit to execute the computer program code with the processor.

The control unit can particularly preferably comprise a power electronics module for energizing the force-feedback actuator and/or the magnetorheological brake. A power electronics module is preferably a combination of different components that provide open- or closed-loop control of a current to the electric machine, preferably including the peripheral components required for this purpose, such as cooling elements or power supply units. In particular, the power electronics module contains a power electronics system or one or more power electronics components that are configured to provide open-or closed-loop control of a current. These are particularly preferably one or more power switches, such as power transistors.

Preferably, the control unit is designed such that it calls up and executes a program for testing the functionality of the magnetorheological brake after receiving a trigger signal. In principle, it would also be conceivable for the functionality of the magnetorheological brake to be tested partially or completely by means of an electronic circuit.

The object of the disclosure can also be achieved by a method for testing the functionality of a magnetorheological brake of an operating unit for influencing a driving direction of a motor vehicle by a user, wherein the operating unit has
a. a rotatably mounted steering shaft, which can be coupled to a steering means, and
b. a force-feedback actuator, which is connected to the steering shaft in a torque-transmitting manner, and
c. a magnetorheological brake, which is likewise connected to the steering shaft in a torque-transmitting manner, and
d. a control unit for controlling the operating unit,
   wherein the method comprises the following steps:
e. receiving a trigger signal for initializing the testing of the functionality,
f. determining an actual parameter which represents the braking effect of the magnetorheological brake and
g. comparing the determined actual parameter with a predefined target parameter and
h. providing a fault signal if a predefined deviation between the actual parameter and the target parameter exists,
i. wherein, in order to determine the braking effect of the magnetorheological brake, the control unit is configured such that the force-feedback actuator provides a motor torque M_{EM} and a test torque M_{R} is applied to the magnetorheological brake and the actual parameter which represents the braking effect represents an angular position of the magnetorheological brake when the test torque M_{R} is applied.

In a first embodiment of the method for testing the functionality of a magnetorheological brake of an operating unit, an angular position of the magnetorheological brake is therefore used as the actual parameter. The control unit is therefore configured such that the force-feedback actuator provides a motor torque M_{EM} and a test torque M_{R} is applied to the magnetorheological brake and the actual parameter which represents the braking effect represents the angular position of the magnetorheological brake when the test torque M_{R} is applied.

With respect to the constructive implementation, an electric motor can, for example, be used as a force-feedback actuator, wherein it is then observed whether, with an expected braking torque or energization of the magnetorheological brake, a slightly greater torque applied for a short time by the force-feedback actuator leads to an incipient rotation of the steering shaft.

Preferably, it is also possible for a trigger signal to be sent to the control unit when the operating unit or the control unit is switched on/off, for example when a vehicle door is opened, which then calls up and executes a program for testing the functionality of the magnetorheological brake in the control unit, for example, so that in chronological/causal sequence, the magnetorheological brake is controlled with a (low) test torque M_{R} (incl. base friction) and the force-feedback actuator is controlled briefly with a motor torque M_{EM}, which is preferably similar to the test torque M_{R}. It is particularly preferred that the motor torque M_{EM} of the electric motor is slightly greater than the test torque of the magnetorheological brake M_{R} so that an incipient slow rotary movement of the steering shaft and thus of the rotor of the magnetorheological brake can be expected.

Preferably, the motor torque M_{EM} of the force-feedback actuator is between 0.1-1.0 Nm. Furthermore, the test torque M_{R} of the magnetorheological brake is between 0.1-1.0 Nm. The motor torque M_{EM} of the electric motor is preferably slightly greater than the test torque of the magnetorheological brake M_{R}.

During and at the end of energizing the motor, for example, the angle of rotation of the rotor of the electric motor can then be determined, which can preferably already be achieved via commutation of the electric motor. This allows the change in angle W compared to the starting state to be acquired.

In a preferred embodiment of the disclosure, if the change in angle while testing the functionality exceeds a predefined threshold, the motor energization is interrupted prematurely in order to avoid excessive changes in angle while testing the functionality of the magnetorheological brake, which would then also be perceived by a user in an unpleasant manner via the steering means. If a corresponding interruption occurs while testing the functionality due to the angle being exceeded, the time until the interruption can also be used as an actual parameter to determine the braking effect of the magnetorheological brake.

In this context, angle thresholds between 1°-5° are preferable, as they offer a good compromise between testing accuracy and limiting the steering shaft deflection while testing the functionality of the magnetorheological brake.

The method for testing the functionality of a magnetorheological brake of an operating unit by means of an angular position change is also applicable with respect to permanent magnet-assisted magnetorheological brakes or magnetorheological brakes with mechanical constant base friction. It is also conceivable that multiple torque levels are tested, for example the base friction and the actuated friction.

A substantial advantage of the method for testing the functionality of a magnetorheological brake by means of the described monitoring of the angular position is that the method can be carried out with the components of the operating unit that are generally already present and available, which makes such a method particularly interesting from an economic point of view.

Furthermore, the disclosure can also be further developed in that the force-feedback actuator comprises an electric motor which can be energized by the control unit so that a motor torque M_{EM} can be applied to the steering shaft by the electric motor.

The motor torque M_{EM} of the force-feedback actuator preferably corresponds to 1.0001-1.2000, particularly preferably 1.0010-1.1000 times the test torque M_{R} of the magnetorheological brake. This ensures that the steering shaft or the steering means secured to it does not make any excessive angular movements while testing the functionality of the brake, which could cause irritation for a user, especially when testing the functionality while the motor vehicle is being driven.

According to a further preferred embodiment of the disclosure, the actual parameter which represents an angular position of the magnetorheological brake can be determined by means of a rotor position sensor provided for commutating the electric motor. This means that a rotor position sensor, which is usually already present and available, can be used to determine the angular position, which can reduce the corresponding manufacturing costs of the system. Since both the commutated electric motor and the magnetorheological brake are located on a common steering shaft or are connected to it in a rotationally fixed manner, the angular position can also be determined in the electric motor and not necessarily on or in the magnetorheological brake.

The magnetorheological brake can preferably be energized in order to generate the test torque M_{R}. In principle, however, it is also possible for the magnetorheological brake to have a currentless base braking torque that can also serve as the test torque M_{R}.

In a further embodiment of the method for testing the functionality of a magnetorheological brake of an operating unit, a magnetic resistance and/or the inductance can be used as actual parameters in addition to the angular position. This makes it possible to check or validate the testing of the functionality of the magnetorheological brake based on the angular position with an additional actual parameter, which can contribute to an improved testing of the functionality of a safety-relevant function of the operating unit due to the provided redundancy.

In this case, a correspondingly supplemented diagnosis of the functionality of the magnetorheological brake can further be based on the presence of the magnetorheological medium through its influence on the magnetic resistance or the inductance with respect to chain formation of the magnetorheological medium. The magnetorheological medium, for example a magnetorheological powder, has a higher magnetic resistance before it is affected by a magnetic field than the magnetorheological chains formed after the magnetic field has affected the magnetorheological medium.

In a magnetorheological brake, for example, a powdery magnetorheological medium can be kept ready in “valleys” so that when the magnetic field is applied, it only has to “climb the mountains” to form the corresponding magnetorheological chains, which then generate the braking torque between the stationary and movable brake part. In this example, “mountains” are the zones on the movable or stationary brake component where the gap distance between the stationary and movable parts of the brake is particularly small. The term “valleys” refers to those zones, produced as turning grooves, for example, where the distance between the stationary and movable brake parts is greater locally and is therefore crossed by fewer field lines.

If a corresponding trigger signal is present, which can, for example, represent the system being switched off (ignition) or the system coming to a standstill (steering angle constant, for example straight ahead), the magnetorheological brake is then controlled in a chronological/causal sequence in a pulse-like manner for 0.1-1s, preferably where U=const with a predetermined voltage U after a rest period, in addition to testing the functionality by means of the angular position. The current I(t) flowing through the excitation coil of the magnetorheological brake is measured, for example inductively or as a voltage drop across a measuring resistor. This current curve I(t) can then be analyzed with regard to the existence of a course that deviates from a target course, for example without a minimum Iₘ at a point in time tₘ in a predetermined time window t₁ . . . t₂. This minimum is indicative of the fact that the powder particles of the magnetorheological medium form chains, due to which the magnetic resistance decreases. If the minimum Iₘ is missing and/or if there is a point in time tₘ outside of t₁ . . . t₂ and/or if the value of Iₘ is too high, a fault signal can be output. This fault is indicative, for example, of a loss of magnetorheological particles, for example due to a seal failure, and/or a loss of their magnetic properties, for example due to oxidation and/or a loss of their movability, for example due to clumping.

In an advantageous further development of the disclosure, a fault signal can also be generated and provided if the value Iₘ is too low (in absolute terms and/or compared to the starting value I at t=0) and/or if the point in time tₘ is too early. This type of fault is indicative of metal abrasion in the magnetorheological shear gap between the rotor and stator of the brake, or of the shear gap surfaces contacting unintentionally.

A low measuring voltage or measuring current can also be applied to the magnetorheological brake for a limited time and the electric resistance R₀ of the excitation coil of the brake can be determined. Preferably, if the value R₀ is too low (indicative of an electric short circuit) or the value R₀ is too high (indicative of an electric cable break), a fault signal can be output.

The method for testing the functionality of a magnetorheological brake of an operating unit, in which a magnetic resistance and/or the inductance are used as actual parameters, can also be applied to permanent magnet-assisted brakes and is selectively sensitive to the presence of the magnetorheological medium. When controlled with constant current, the chronological course of the voltage—analogous to the current curve described above—must be measured and analyzed.

One advantage of this method variant is the provision of a purely electric method without the need for mechanically movable components.

In a further, alternative embodiment of the method for testing the functionality of a magnetorheological brake of an operating unit, the electric resistance between the rotor and stator of the magnetorheological brake can be used as an actual parameter in addition to the angular position. This also makes it possible to check or validate the testing of the functionality of the magnetorheological brake based on the angular position with an additional actual parameter, which can contribute to an improved testing of the functionality of a safety-relevant function of the operating unit due to the provided redundancy. Of course, it is also possible to validate the testing of the functionality of the magnetorheological brake by means of the angular position using both the magnetic resistance and/or inductance and the electric resistance between the rotor and stator of the magnetorheological brake, which can further improve the verification of the functionality of the magnetorheological brake.

In this case, this allows for a supplemented diagnosis of the presence of the magnetorheological medium based on its influence on the electric resistance between the rotor and stator of the magnetorheological brake.

According to this further preferred embodiment of the subject matter of the disclosure, the actual parameter which represents the braking effect can correspond to a current curve when energizing an excitation coil of the magnetorheological brake.

In this preferred embodiment of the disclosure, the actual parameter which represents the braking effect can also correspond to an electric resistance between a rotor and a stator of the magnetorheological brake.

With respect to the constructive implementation, the rotor and stator of the magnetorheological brake can be electrically insulated, for example using plastic sleeves on the bearing seats,

and/or an elastomer coupling between the rotor and steering shaft. A test voltage can then be applied to the rotor via a sliding contact, for example, wherein no or only a low current flows to the stator in this case, as the conductive particles of the magnetorheological medium only form a loose bulk. If the flowing current is too high, i.e., exceeds a predefined target value, a fault is inferred, for example caused by magnetorheological medium clumping together.

A test magnetic field can then be activated, in particular by energizing the excitation coil of the magnetorheological brake, and the increase in the test current can be measured, as the magnetic field causes electrically conductive chains of magnetorheological particles to be formed. If the test current does not increase or does not increase sufficiently, a fault, such as a lack of magnetorheological medium, is inferred.

This method can be used for both permanent magnet-assisted brakes and magnetorheological brakes with mechanical constant base friction. As applicable, multiple torque levels can also be tested, for example the base friction and the reduced friction with magnetic field cancellation.

Here, too, there is the advantage that an additional, purely electric method can be provided without the need for mechanically movable components.

In principle, it is possible for the testing of the functionality of the magnetorheological brake by means of the angular position as an actual parameter to be performed with a time delay, overlapping in time or simultaneously with the additional functionality testing based on the magnetic resistance and/or the inductance or the electric resistance between the rotor and stator of the magnetorheological brake.

According to a further preferred further development of the disclosure, the trigger signal can represent an opening of the driver-side door of the motor vehicle or can represent a starting of the motor vehicle, or can represent the standstill of the motor vehicle, can represent a switching off of the motor vehicle, can represent an exiting of the motor vehicle by the user, or can represent a command of a workshop test device. It is advantageous in this regard if the trigger signal is generated, in each case, before the operating unit is used. In principle, it would also be conceivable for a trigger signal to be generated after the operating unit has been used, for example when exiting the vehicle. Furthermore, a trigger signal can also occur while the operating unit is in use, for example when driving straight ahead. In particular, it is conceivable that the trigger signal is sent from a higher-level control unit of the motor vehicle to the control unit of the operating unit.

Furthermore, according to a likewise advantageous embodiment of the disclosure, the fault signal can cause a fault memory entry and/or can generate an optical and/or acoustic warning signal and/or can cause a speed limitation of the motor vehicle. It is also conceivable that the fault signal initiates a temporarily higher energization of a force-feedback actuator having an electric motor in order to fully or at least in part compensate for the loss of braking torque with a higher motor torque.

It can also be advantageous to further develop the disclosure in such a way that the magnetorheological brake is designed as a permanently excited magnetorheological brake. The advantage of this is that the current required to achieve a braking torque is lower and, in the event of a fault, a base friction suitable for emergency running is provided.

The object of the disclosure can furthermore be achieved by a computer program product stored on a machine-readable carrier, or a computer data signal embodied by an electromagnetic wave, having a computer program code suitable for carrying out a method.

Finally, the object of the disclosure can also be achieved by a steer-by-wire system for a motor vehicle comprising an operating unit according to any one of the preceding claims and/or a control unit which is designed to carry out a method.

The disclosure is explained in more detail below with reference to figures without limiting the general concept of the disclosure.

### BRIEF DESCRIPTION OF THE DRAWINGS

In the figures:

FIG. 1 shows a motor vehicle having a steer-by-wire system in a schematic block diagram,

FIG. 2 shows a first embodiment of an operating unit in a schematic axial sectional view,

FIG. 3 shows a second embodiment of an operating unit in a schematic axial sectional view,

FIG. 4 shows the chronological current curve while testing the functionality of a magnetorheological brake, in which a magnetic resistance and/or the inductance are used as actual parameters,

FIG. 5 shows a third embodiment of an operating unit in a schematic axial sectional view,

FIG. 6 shows the chronological signal curve while testing the functionality of a magnetorheological brake, in which a mechanical braking torque or an incipient movement is used as the actual parameter,

FIG. 7 shows the chronological signal curve while testing the functionality of a magnetorheological brake, in which a mechanical braking torque or an incipient movement is used as the actual parameter, with a first and a second course in a separate diagram in each case.

### DETAILED DESCRIPTION

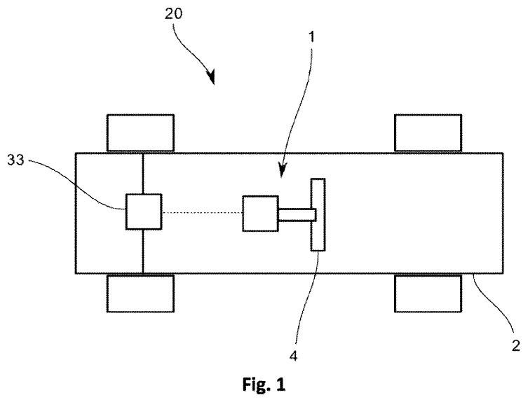

FIG. 1 shows an operating unit 1 for influencing the driving direction of a motor vehicle 2 by a user. The operating unit 1 is integrated in a steer-by-wire system 20 so that a steering movement of the steering means 4 is transmitted electrically from the operating unit 1 to an RWA 33 (road wheel actuator), which then adjusts the corresponding steering angle on the vehicle wheels of the vehicle axle.

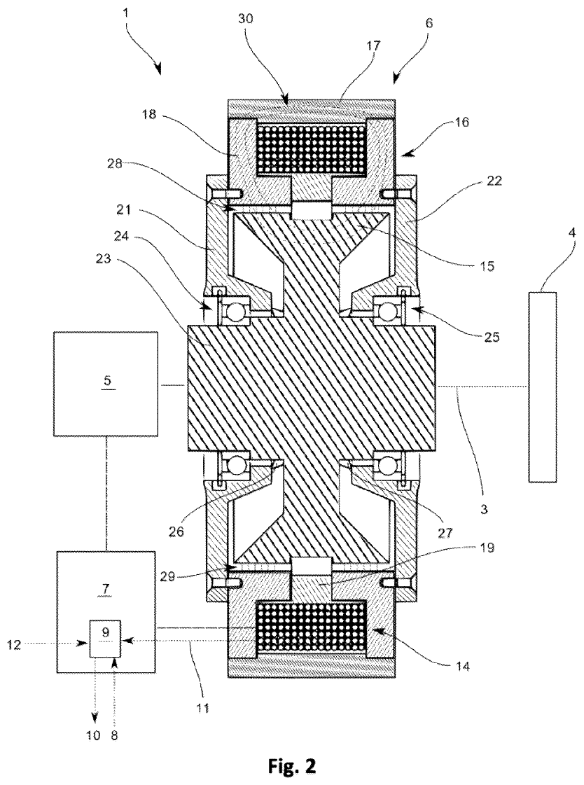

As can be clearly seen from FIG. 2, the operating unit 1 has a rotatably mounted steering shaft 3 (this can also be designed as a hollow shaft or outer rotor), which can be coupled to the steering means 4, as well as a force-feedback actuator 5, which is also connected to the steering shaft 3 in a torque-transmitting manner. Furthermore, the operating unit 1 has a magnetorheological brake 6, which is also connected to the steering shaft 3 in a torque-transmitting manner. The force-feedback actuator 5, the magnetorheological brake 6 and the steering means 4 thus lie on a common torque path.

Furthermore, the operating unit 1 has a control unit 7 for controlling the operating unit 1, wherein the control unit 7 is designed to call up and execute a program 9 for testing the functionality of the magnetorheological brake 6 after a trigger signal 8, wherein the control unit 7 provides a fault signal 10 upon ascertaining that the magnetorheological brake 6 has fallen below a predefined braking effect.

Thus, the operating unit 1 shown in FIG. 2 can be used to carry out a method for testing the functionality of a magnetorheological brake 6, wherein the operating unit 1 has
a. a rotatably mounted steering shaft 3, which can be coupled to a steering means 4, and
b. a force-feedback actuator 5, which is connected to the steering shaft 3 in a torque-transmitting manner, and
c. a magnetorheological brake 6, which is likewise connected to the steering shaft 3 in a torque-transmitting manner, and
d. a control unit 7 for controlling the operating unit 1, and wherein the method comprises the following steps:
e. receiving a trigger signal 8 for initializing the testing of the functionality,
f. determining an actual parameter 11 which represents the braking effect of the magnetorheological brake 6 and
g. comparing the determined actual parameter 11 with a predefined target parameter 12 and
h. providing a fault signal 10 if a predefined deviation between the actual parameter 11 and the target parameter 12 exists,
i. wherein, in order to determine the braking effect of the magnetorheological brake 6, the control unit 7 is configured such that the force-feedback actuator 5 provides a motor torque M_{EM} and a test torque M_{R} is applied to the magnetorheological brake 6 and the actual parameter 11 which represents the braking effect represents an angular position of the magnetorheological brake 6 when the test torque M_{R} is applied.

The magnetorheological brake 6 has an electromagnet with an energizable excitation coil 14, the field lines 30 of which extend through the stator 16 and the rotor 15 connected to the steering shaft 3.

The ring-shaped excitation coil 14 is received in a coil carrier 18 with a U-shaped cross-section, which is closed radially on the outside by the coil closure 17. The coil carrier 18 is closed radially on the inside by the coil closure 19. The coil carrier 18 and the coil closure 17 are formed from a ferromagnetic material. The excitation coil 14, the coil carrier 18 and the coil closure 17 form the stator 16 of the brake 6. The stator 16 is mounted via the end shields 21,22 and the rolling bearings 24,25 on the rotatable brake shaft 23, which is part of the rotor 15. The rotor 15 is sealed with respect to the end shields 21,22 by the seals 26,27.

In the method described for testing the functionality of the magnetorheological brake 6 of the operating unit 1, an angular position is used as the actual parameter 11. In this case, a braking torque is first generated by energizing the excitation coil 14 of the magnetorheological brake 6 and then the electric motor 13 is energized for a short time or vice versa. If this results in an excessive rotary movement of the steering shaft 3, which is stored as a target parameter 12 in the control unit 7, a fault is identified and a fault signal 10 is provided.

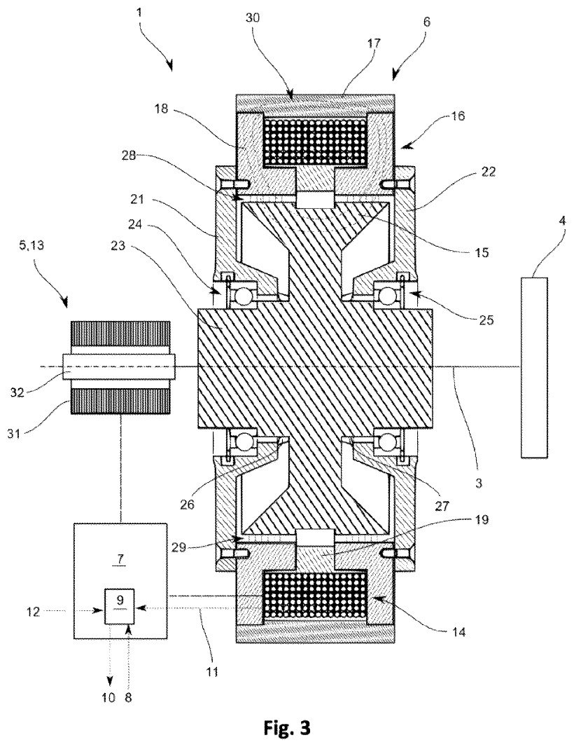

The force-feedback actuator 5 thus comprises an electric motor 13 which can be energized by the control unit 7 so that a motor torque M_{EM} can be applied to the steering shaft by the electric motor 13. This is shown in FIG. 3. For its part, the electric motor 13 comprises a stator 31 and a rotor 32 that can rotate relative thereto and is connected to the steering shaft 3.

Furthermore, the program 9 is configured such that the test torque M_{R} is applied to the magnetorheological brake 6 and the actual parameter 11 which represents the braking effect is the angular position of the magnetorheological brake 6 when the test torque M_{R} is applied.

Because the motor torque M_{EM} is only slightly higher than the test torque M_{R}, the steering shaft 3 only starts to rotate comparatively slowly, which can be analyzed with the help of the rotor position sensor of the electric motor 13, which is already present and available for its commutation.

If the rotary movement of the steering shaft 3 is too weak, possibly even with a higher energization of the electric motor 13, it can be inferred that there is excessive friction or even jamming of the steering shaft 3. If the rotary movement is too strong, which can possibly be validated by means of repeat measurement and/or a fault counter, a loss of function of the brake 6 can be inferred. Preferably, the rotary movement of the steering shaft 3 is between 1-5° when testing the functionality. A larger angle of rotation >5° then indicates a loss of braking force of the magnetorheological brake 6 and a small angle of rotation <1° indicates excessive friction.

The method can also be used with adapted thresholds and test torques if the magnetorheological brake 6 generates a currentless base braking torque.

The trigger signal 8 can represent, for example, an opening of the driver-side door of the motor vehicle 2, a starting of the motor vehicle 2, the standstill of the motor vehicle 2, a switching off of the motor vehicle 2, a command of a workshop test device or the user exiting the motor vehicle 2. The fault signal 10 can, for example, cause a fault memory entry and/or generate an optical and/or acoustic warning signal and/or cause a speed limitation of the motor vehicle 2.

A reliable characteristic curve, torque=f(current), is required for the quantitatively precise control of the magnetorheological brake 6, for example with support points and interpolation. In friction-based controls, adaptation functions are commonly used to correct individual variations (adaptation during production or end-of-line testing) and lifetime changes (adaptation in the workshop or during vehicle operation in selected situations). The magnetorheological brake 6 is controlled using a characteristic curve f and at least one parameter, here “R” in the form M=R*f(I).

The parameter R is adapted, at least at the start of a vehicle operating phase or after the end of a vehicle operating phase.

During adaptation, the diagnostic method of torque comparison is used and the magnetorheological brake 6 and the electric motor 13 are energized together. As a result of the adaptation, the adaptive parameter R is limited, and reaching the limits can serve as a trigger for a fault signal 10 and corresponding fault entries and/or warning/emergency running functions. If there is a loss of particles in the magnetorheological brake 6, the adaptation would continuously reduce the parameter R to compensate for this drop in braking torque capacity. Reaching predetermined adaptation limits is therefore indicative of a fault in the brake 6.

In addition to the multiplicatively acting parameter R described here (illustrative: could also be the friction coefficient, hence R), additively acting adaptive parameters E of the form M=E +f(I), adaptive parameters A additively acting in the characteristic curve argument of the form M=f(I+A), adaptive parameters B multiplicatively acting in the characteristic curve argument of the form M=f(I*B), or combinations thereof are also conceivable as equivalents. These representations can be particularly useful if, for example, a characteristic curve offset is created by a permanent magnet or a specific magnetization remanence.

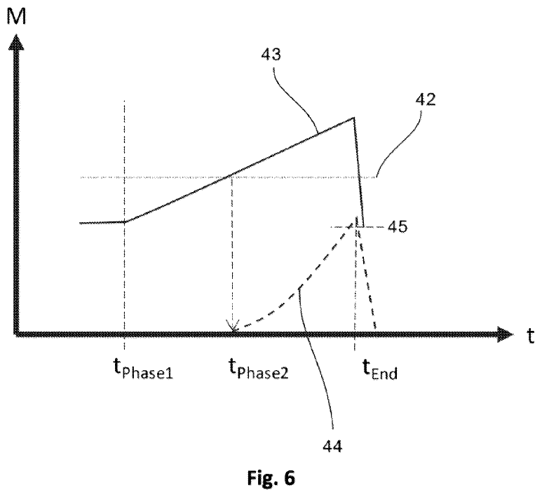

As can be seen in FIG. 6, in a first phase of adaptation between t_{Phase1} and t_{Phase2}, the controlled actuator torque 43 of the electric motor 13 is below the controlled expected braking torque 42. Consequently, no rotation of the steering shaft 3 is expected.

In a second phase of adaptation, at >t_{Phase2}, the controlled actuator torque 43 is above the controlled expected braking torque 42 so that a rotation and an angle of rotation 44 of the steering shaft 3 are expected.

After a given time or when the movement exceeds a safe detection threshold, designated with t_{End} in FIG. 6, the actuator torque 43 is quickly reduced to stop or even reverse the rotation of the steering shaft 3.

The adaptation can be carried out both with a ramp-shaped course (as shown) of the actuator torque 43, as well as with other courses (steps, . . . ), as long as the two phases “<braking torque 42” and “>braking torque 42” exist.

Similarly, the braking torque 42 can be controlled both constantly (as shown) or with a decreasing ramp or otherwise, as long as the two phases “<braking torque 42” and “>braking torque 42” exist. The control can also vary before the start of phase 1, for example by the actuator torque 43 being switched on first or the braking torque 42.

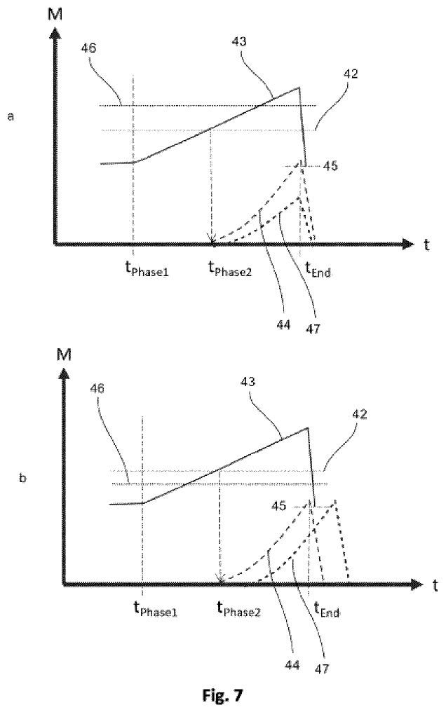

If—as can be seen in Part a of FIG. 7—the angle of rotation 47 is smaller than the expected angle of rotation 44 and does not exceed a threshold value 45, for example, it is inferred that the braking torque 46 is actually greater. The adaptive parameter R, which is used in the control formula M=R*f(I) or I=f⁻¹(M/R), is increased for correction. Here, f⁻¹ symbolizes the mathematical inverse function or the inverse interpolation of the corresponding lookup table. The increase can be made in steps or on the basis of the actual rotary movement achieved, but is limited to minimum and maximum values. If the angle of rotation 47 is greater than expected (or, as shown, the threshold value is reached early and the EM torque is reduced), it is inferred that the braking torque 42 is actually greater and the adaptive parameter R is reduced, making the control more precise in the future.

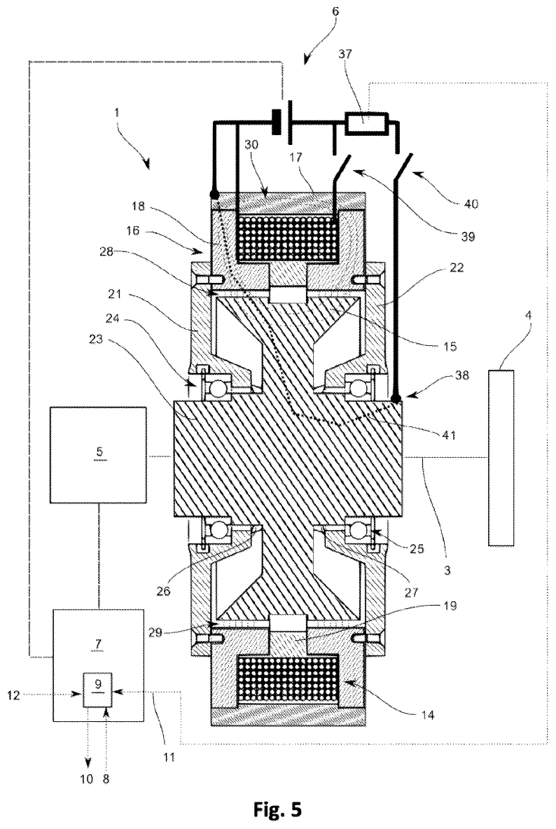

FIG. 5 shows an embodiment of the operating unit 1 in which, in addition to the actual parameter of the angular position, an additional actual parameter 11 which represents the braking effect corresponds to an electric resistance between a rotor 15 and a stator 16 of the magnetorheological brake 6.

This produces an additional contact with the coil closure 17 and a sliding contact 38 to the steering shaft 3, between which a test current 41 can flow through the magnetorheological brake 6, which is provided, for example, by the control unit 7. Here, the test resistor 37 limits the test current to the sliding contact 38. The switch 40 can be used to switch the test current 41 on and off in a targeted manner in order to be able to cut it off from leakage currents, for example. The rolling bearings 24,25 have an electric insulating effect between the rotor 15 and the stator 16 of the magnetorheological brake 6, for example by means of a sheath, coating, ceramic balls or the like. This ensures that the test current 41 cannot flow past the magnetorheological chains of the magnetorheological medium 29 in the gap 28 to the sliding contact 38.

The rotor 15 and the stator 16 are thus electrically insulated, for example by plastic sleeves on the rolling bearings 24,25. A test voltage is applied to the rotor 15 via the sliding contact 38, wherein no or only a low test current 41 flows to the stator 16, as the conductive magnetorheological particles of the magnetorheological medium 29 only form a loose bulk.

If the flowing test current 41 is too high, i.e., exceeds a predetermined target value, a fault such as a clumping magnetorheological medium 29 is inferred.

A test magnetic field is then activated by energizing the excitation coil 14, and the increase in the test current 41 is measured, as the magnetic field causes electrically conductive chains of magnetorheological particles to be formed in the gap 28 between the rotor 15 and the stator 16 of the magnetorheological brake 6.

If the test current 41 does not increase or does not increase sufficiently, a fault, such as a lack of magnetorheological medium 29, is inferred and a corresponding fault signal 10 is generated.

The energization of the excitation coil 14 can be controlled via the switch 39.

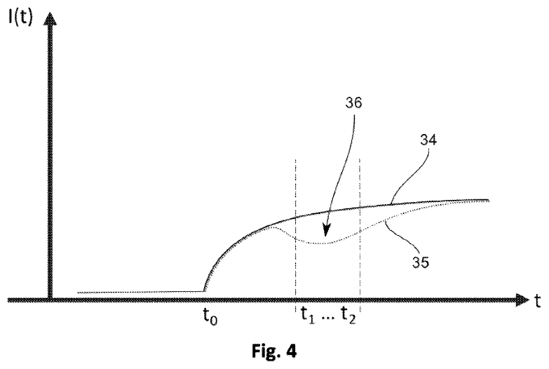

On the basis of the synopsis of FIG. 2 with FIG. 4, a further diagnostic method in addition to the method based on the angular position is explained in more detail, wherein the additional actual parameter 11 which represents the braking effect corresponds to a current curve when energizing an excitation coil 14 of the magnetorheological brake 6.

This allows for an additional diagnosis of the presence of the magnetorheological medium 29 based on its influence on the magnetic resistance or the inductance when the magnetorheological medium 29 forms chains. The magnetorheological medium 29, for example a magnetorheological powder, has a higher magnetic resistance before it is affected by a magnetic field than the magnetorheological chains formed after the effect of the magnetic field on the magnetorheological medium 29.

If a corresponding trigger signal 8 is present, which can, for example, represent the system being switched off (ignition) or the system coming to a standstill (steering angle constant, for example straight ahead), the magnetorheological brake 6 is then controlled in a chronological/causal sequence in a pulse-like manner for 0.1-1 s, preferably where U=const with a predetermined voltage U after a rest period. The current I(t) flowing through the excitation coil 14 of the magnetorheological brake 6 is measured, for example inductively or as a voltage drop across a measuring resistor.

As shown in FIG. 4, the current curve 34 is plotted for a situation with an excitation coil 14 without the presence of a magnetorheological medium 29. In contrast, in the current curve 35, which shows the situation of the excitation coil 14 when the magnetorheological medium 29 is present, the mechanical dynamics of the chain formation of the magnetorheological particles causes a current minimum 36 between t₁ . . . t₂.

This current curve I(t), which is also sketched in FIG. 4, can then be analyzed with regard to the existence of a minimum 36 Iₘ at a point in time tm in a predetermined time window t₁ . . . t₂. This minimum 36 is indicative of the fact that the powder particles of the magnetorheological medium 29 form chains, due to which the magnetic resistance decreases. If the minimum 36 is missing and/or if there is a point in time tm outside of t₁ . . . t₂ and/or if the value of Iₘ is too high, a fault signal 10 can be output. This fault is indicative, for example, of a loss of magnetorheological particles, for example due to a seal failure, and/or a loss of their magnetic properties, for example due to oxidation and/or a loss of their movability, for example due to clumping.

In an advantageous further development of the disclosure, a fault signal 10 can also be generated and provided if the value Iₘ is too low (in absolute terms and/or compared to the starting value I at t=0) and/or if the point in time tₘ is too early. This type of fault is indicative of metal abrasion in the magnetorheological gap 28 between the rotor 15 and stator 16 of the brake 6, or of the shear gap surfaces contacting unintentionally.

A low measuring voltage or measuring current can also be applied to the magnetorheological brake 6 for a limited time and the electric resistance R₀ of the excitation coil 14 of the brake 6 can be determined. Preferably, if the value R₀ is too low (indicative of an electric short circuit) or the value R₀ is too high (indicative of an electric cable break), a fault signal 10 can be output.

The disclosure is not limited to the embodiments shown in the figures. The above description is therefore not to be regarded as limiting, but rather as illustrative. The following claims are to be understood as meaning that a stated feature is present in at least one embodiment of the disclosure. This does not exclude the presence of further features. Where the claims and the above description define ‘first’ and ‘second’ features, this designation serves to distinguish between two features of the same type without defining an order of precedence.

### LIST OF REFERENCE SIGNS

1 Operating unit
2 Motor vehicle
3 Steering shaft
4 Steering means
5 Force-feedback actuator
6 Brake
7 Control unit
8 Trigger signal
9 Program
10 Fault signal
11 Actual parameter
12 Target parameter
13 Electric motor
14 Excitation coil
15 Rotor
16 Stator
17 Coil closure
18 Coil carrier
19 Coil closure
20 Steer-by-wire system
21 End shield
22 End shield
23 Brake shaft
24 Rolling bearing
25 Rolling bearing
26 Seal
27 Seal
28 Gap
29 Medium
30 Field lines
31 Stator
32 Rotor
33 RWA
34 Current curve
35 Current curve
36 Minimum
37 Test resistor
38 Sliding contact
39 Switch
40 Switch
41 Test current
42 Braking torque
43 Actuator torque
44 Angle of rotation
45 Threshold value
46 Braking torque
47 Angle of rotation

1. An operating unit for influencing a driving direction of a motor vehicle by a user, comprising:
a rotatably mounted steering shaft which can be coupled to a steering means,
a force-feedback actuator, which is connected to the steering shaft in a torque-transmitting manner,
a magnetorheological brake, which is likewise connected to the steering shaft in a torque-transmitting manner, and
a control unit for controlling the operating unit,
wherein
the control unit is configured to call up and execute a program for testing the functionality of the magnetorheological brake after a trigger signal, wherein the control unit provides a fault signal if it is ascertained that the magnetorheological brake has fallen below a predefined braking effect, wherein the program is configured such that the force-feedback actuator provides a motor torque M_{EM} and a test torque M_{R} is applied to the magnetorheological brake, and an actual parameter which represents the braking effect is the-an angular position of the magnetorheological brake when the test torque M_{R} is applied.

2. A method for testing the functionality of a magnetorheological brake of an operating unit for influencing a driving direction of a motor vehicle by a user, wherein the operating unit has
a rotatably mounted steering shaft, which can be coupled to a steering means,
a force-feedback actuator, which is connected to the steering shaft in a torque-transmitting manner,
a magnetorheological brake, which is likewise connected to the steering shaft in a torque-transmitting manner, and
a control unit for controlling the operating unit
wherein the method comprises the following steps:
receiving a trigger signal for initializing the testing of the functionality,
determining an actual parameter which represents the-a braking effect of the magnetorheological brake,
comparing the determined actual parameter with a predefined target parameter, and
providing a fault signal if a predefined deviation between the actual parameter and the target parameter exists,
wherein, in order to determine the braking effect of the magnetorheological brake, the control unit is configured such that the force-feedback actuator provides a motor torque M_{EM} and a test torque M_{R} is applied to the magnetorheological brake and the actual parameter which represents the braking effect represents an angular position of the magnetorheological brake when the test torque M_{R} is applied.

3. The method according to claim 2,
wherein
the trigger signal represents at least one of an opening of the a driver-side door of the motor vehicle, or a starting of the motor vehicle, or a standstill of the motor vehicle, or a switching off of the motor vehicle, or an exiting of the motor vehicle by the user, or a command of a workshop test device.

4. The method according to claim 2,
wherein
the fault signal
causes at least one of a fault memory entry or
generates an optical or acoustic warning signal or
causes a speed limitation of the motor vehicle.

5. The method according to claim 2,
wherein
the force-feedback actuator comprises an electric motor which can be energized by the control unit so that a motor torque M_{EM} can be applied to the steering shaft by the electric motor.

6. The method according to claim 5,
wherein
the motor torque M_{EM} corresponds to 1.0001-1.2000, preferably 1.0010-1.1000 times the test torque M_{R}.

7. The method according to claim 5,
wherein
the an actual parameter which represents an angular position of the magnetorheological brake is determined by means of a rotor position sensor provided for commutating the electric motor.

8. The method according to claim 2,
wherein
the magnetorheological brake is energized in order to generate the test torque M_{R}.

9. (canceled)

10. A steer-by-wire system for a motor vehicle comprising an operating unit according to claim 1 and/or a control unit which is designed to carry out a method according to claim 2.

11. The operating unit according to claim 1, wherein the trigger signal represents at least one of an opening of a driver-side door of the motor vehicle, or a starting of the motor vehicle, or a standstill of the motor vehicle, or a switching off of the motor vehicle, or an exiting of the motor vehicle by the user, or a command of a workshop test device.

12. The operating unit according to claim 1, wherein the fault signal causes at least one of a fault memory entry or generates an optical or acoustic warning signal or causes a speed limitation of the motor vehicle.

13. The operating unit according to claim 1, wherein the force-feedback actuator comprises an electric motor which can be energized by the control unit so that a motor torque M_{EM} can be applied to the steering shaft by the electric motor.

14. The operating unit according to claim 13, wherein the motor torque M_{EM} corresponds to 1.0001-1.2000, preferably 1.0010-1.1000 times the test torque M_{R}.

15. The operating unit according to claim 13, wherein an actual parameter which represents an angular position of the magnetorheological brake is determined by a rotor position sensor provided for commutating the electric motor.

16. The operating unit according to claim 1, wherein the magnetorheological brake is energized in order to generate the test torque M_{R}.
